(19) United States
(12) Patent Application Publication
(10) Pub. No.: US 2014/0328234 A1
(43) Pub. Date: Nov. 6, 2014

(54) SYSTEMS AND METHODS FOR POWER SAVE DURING INITIAL LINK SETUP

(71) Applicant: QUALCOMM Incorporated, San Diego, CA (US)

(72) Inventors: George Cherian, San Diego, CA (US); Santosh Paul Abraham, San Diego, CA (US); Jouni Kalevi Malinen, Tuusula (FI)

(73) Assignee: QUALCOMM Incorporated, San Diego, CA (US)

(21) Appl. No.: 14/263,848

(22) Filed: Apr. 28, 2014

Related U.S. Application Data
(60) Provisional application No. 61/818,861, filed on May 2, 2013.

(51) Int. Cl. H04W 52/02; H04W 12/06

(52) U.S. Cl. CPC H04W 52/0229; H04W 12/06
USPC 370/311

(57) ABSTRACT

Systems, methods, and devices for communicating data in a wireless communications network are described herein. In some aspects, a station transmits an authentication request to an access point and for the access point to transmit an authentication initiation request to an authentication server. The station receives an authentication response comprising an estimated response delay from the access point. The station transitions from an awake state to a sleep state for a duration of time based on the estimated response delay. The station transmits an association request to the access point after the duration of time and transitioning from the sleep state to the awake state. The station receives an association response from the access point, where the association response comprises an authentication status that indicates whether authentication with the authentication server is successful.

### CROSS-REFERENCE TO RELATED APPLICATIONS

This application claims priority under 35 U.S.C. §119(e) to U.S. Provisional Application No. 61/818,861, entitled “SYSTEMS AND METHODS FOR POWER SAVE DURING INITIAL LINK SETUP” and filed on May 2, 2013, which is hereby incorporated by reference in its entirety.

### BACKGROUND

1. Field

The present application relates generally to wireless communication systems and more specifically to systems, methods, and devices for fast initial network link setup within wireless communication systems.

2. Background

In many telecommunication systems, communications networks are used to exchange messages among several interacting spatially-separated devices. Networks can be classified according to geographic scope, which could be, for example, a metropolitan area, a local area, or a personal area. Such networks would be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or when the network architecture is formed in an ad hoc, rather than fixed, topology. A mobile network element such as a wireless station (STA) and an access point (AP) can exchange messages through a process of link setup for utilizing the network. Under certain conditions, many STAs can attempt to use the network during a short period of time. For example, when several STAs move into the vicinity of a new network, the network can experience an increased rate of link setup process collisions creating undesirable latencies in the link setup. Accordingly, there is a need for a fast initial link setup in a wireless communication network.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved communications between access points and stations in a wireless network.

One aspect of this disclosure provides a method for communicating data in a wireless communications network. The method comprises transmitting an authentication request to an access point and for the access point to transmit an authentication initiation request to an authentication server. The method further comprises receiving an authentication response comprising an estimated response delay from the access point. The method further comprises transitioning from an awake state to a sleep state in response to receiving the authentication response for a duration of time based on the estimated response delay. The method further comprises transmitting an association request to the access point after the duration of time and transitioning from the sleep state to the awake state. The method further comprises receiving an association response from the access point in response to transmitting the association request. The association response may comprise an authentication status received by the access point from the authentication server. The authentication status may indicate whether authentication with the authentication server is successful.

Another aspect of this disclosure provides an apparatus for communicating data in a wireless communications network. The apparatus comprises means for transmitting an authentication request to an access point and for the access point to transmit an authentication initiation request to an authentication server. The apparatus further comprises means for receiving an authentication response comprising an estimated response delay from the access point. The apparatus further comprises means for transitioning from an awake state to a sleep state in response to receiving the authentication response for a duration of time based on the estimated response delay. The apparatus further comprises means for transmitting an association request to the access point after the duration of time and transitioning from the sleep state to the awake state. The apparatus further comprises means for receiving an association response from the access point in response to transmitting the association request. The association response may comprise an authentication status received by the access point from the authentication server. The authentication status may indicate whether authentication with the authentication server is successful.

Another aspect of this disclosure provides a non-transitory computer-readable medium comprising code that, when executed, causes an apparatus to transmit an authentication request to an access point and for the access point to transmit an authentication initiation request to an authentication server. The medium further comprises code that, when executed, causes an apparatus to receive an authentication response comprising an estimated response delay from the access point. The medium further comprises code that, when executed, causes an apparatus to transition from an awake state to a sleep state in response to receiving the authentication response for a duration of time based on the estimated response delay. The medium further comprises code that, when executed, causes an apparatus to transmit an association request to the access point after the duration of time and transitioning from the sleep state to the awake state. The medium further comprises code that, when executed, causes an apparatus to receive an association response from the access point in response to transmitting the association request. The association response may comprise an authentication status received by the access point from the authentication server. The authentication status may indicate whether authentication with the authentication server is successful.

Another aspect of this disclosure provides an apparatus for communicating data in a wireless communications network. The apparatus comprises a transmitter configured to transmit an authentication request to an access point and for the access point to transmit an authentication initiation request to an authentication server. The apparatus further comprises a receiver configured to receive an authentication response comprising an estimated response delay from the access point. The apparatus further comprises a power save controller configured to transition the apparatus from an awake state to a sleep state in response to receiving the authentication response for a duration of time based on the estimated response delay. The transmitter may be further configured to transmit an association request to the access point after the duration of time and transitioning from the sleep state to the awake state. The receiver may be further configured to receive an association response from the access point in response to transmitting the association request. The association response may comprise an authentication status received by the access point from the authentication server. The authentication status may indicate whether authentication with the authentication server is successful.

### BRIEF DESCRIPTION OF THE DRAWINGS

FIG. 1 shows an exemplary wireless communication system in which aspects of the present disclosure can be employed.

FIG. 2 shows a communication exchange in a fast initial link setup (FILS) wireless communication system.

FIG. 3 shows an exemplary communication exchange in the wireless communication system of FIG. 1.

FIG. 4 shows another exemplary communication exchange in the wireless communication system of FIG. 1.

FIG. 5 shows another exemplary communication exchange in the wireless communication system of FIG. 1.

FIG. 6 shows a functional block diagram of an exemplary a wireless device that can be employed within the wireless communication system of FIG. 1.

FIG. 7 is a flowchart of a process for communicating data in the wireless communications system of FIG. 1.

FIG. 8 is a flowchart of a process for communicating data in the wireless communications system of FIG. 1.

FIG. 9 is a flowchart of a process for communicating data in the wireless communications system of FIG. 1.

FIG. 10 is a flowchart of a process for communicating data in the wireless communications system of FIG. 1.

FIG. 11 is a flowchart of a process for communicating data in the wireless communications system of FIG. 1.

FIG. 12 is a flowchart of a process for communicating data in the wireless communications system of FIG. 1.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

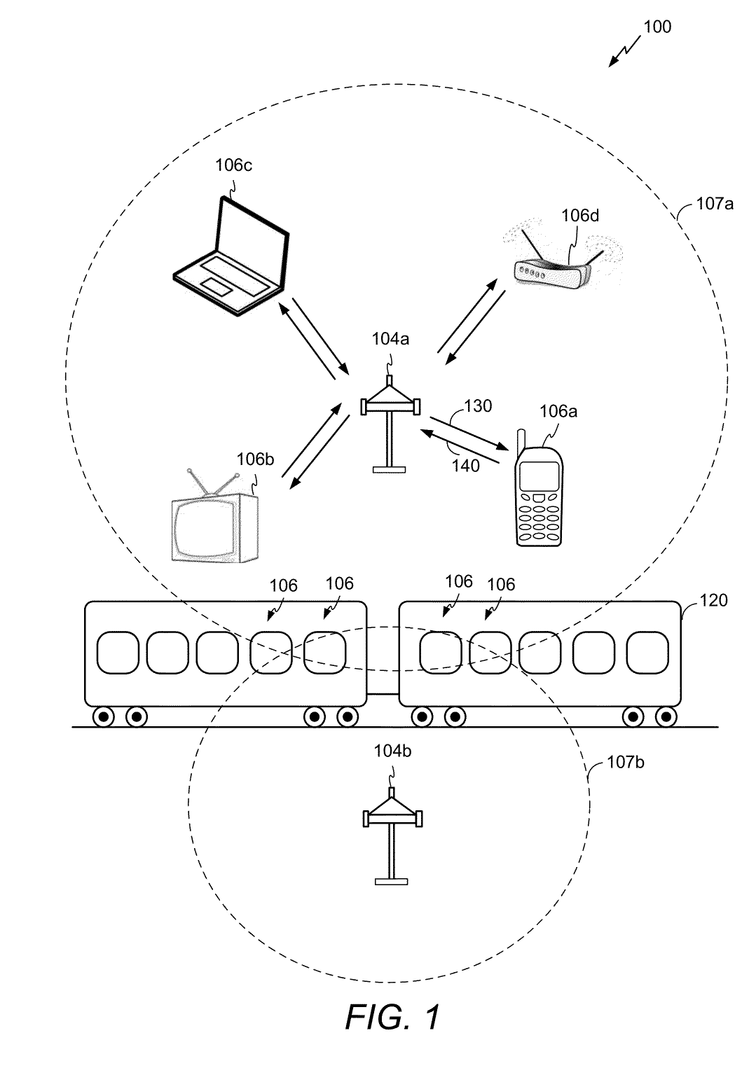

FIG. 1 shows an exemplary wireless communication system 100 in which aspects of the present disclosure can be employed. The wireless communication system 100 includes an access point (AP) 104a, which communicates with a plurality of stations (STAs) 106a-106d in a basic service area (BSA) 107a. The wireless communication system 100 can further include a second AP 104b which can communicate in a BSA 107b. One or more STAs 106 can move in and/or out of the BSAs 107a-107b, for example, via a train 120. In various embodiments described herein, the STAs 106 and 106a-106d can be configured to quickly establish wireless links with the AP 104a and/or 104b, particularly when moving into the BSAs 107a and/or 107b.

The various fast initial link setup (FILS) implementations described herein can provide enhanced system performance under a variety of use conditions. In some embodiments, when a large number of STAs 106 move into range of an AP 104a and/or 104b, they can create a large amount of wireless traffic, for example, in an attempt to establish a wireless link with the AP 104a. In some instances, the STAs 106 can generate hundreds of connection attempts per second. A high number of STAs 106 requesting access can cause packet collisions and/or dropping of packets, thereby potentially reducing network performance and increasing latency. The increased latency may cause STAs 106 to remain idle for longer periods of time, thereby increasing power consumption. Accordingly, a faster initial link setup that utilizes techniques for allowing STAs 106 to enter a sleep state (e.g., an inactive state, a state in which some or all of the components of the STAs 106 are powered down to reduce power consumption, etc.) during the connection process can reduce power consumption. As described in greater detail herein, the devices 106 and 104a-104b can implement various techniques to reduce power consumption, and thereby enhance network performance.

In various embodiments, the wireless communication system 100 can include a wireless local area network (WLAN). The WLAN can be used to interconnect nearby devices, employing one or more networking protocols. The various aspects described herein can apply to any communication standard, such as IEEE 802.11 wireless protocols. For example, the various aspects described herein can be used as part of the IEEE 802.11a, 802.11b, 802.11g, 802.11n, 802.11ah, and/or 802.11ai protocols. Implementations of the 802.11 protocols can be used for sensors, home automation, personal healthcare networks, surveillance networks, metering, smart grid networks, intra- and inter-vehicle communication, emergency coordination networks, cellular (e.g., 3G/4G) network offload, short- and/or long-range Internet access (e.g., for use with hotspots), machine-to-machine (M2M) communications, etc.

The APs 104a-104b can serve as a hub or base station for the wireless communication system 100. For example, the AP 104a can provide wireless communication coverage in the BSA 107a, and the AP 104b can provide wireless communication coverage in the BSA 107b. The AP 104a and/or 104b can include, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, or some other terminology.

The STAs 106 and 106a-106d (collectively referred to herein as STAs 106) can include a variety of devices such as, for example, laptop computers, personal digital assistants (PDAs), mobile phones, etc. The STAs 106 can connect to, or associate with, the APs 104a-104b via a WiFi (e.g., IEEE 802.11 protocol such as 802.11ai) compliant wireless link to obtain general connectivity to the Internet or to other wide area networks. The STAs 106 may also be referred to as “clients.”

In various embodiments, the STAs 106 can include, be implemented as, or be known as access terminals (ATs), subscriber stations, subscriber units, mobile stations, remote stations, remote terminals, user terminals (UTs), terminals, user agents, user devices, user equipment (UEs), or some other terminology. In some implementations, a STA 106 can include a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The AP 104a, along with the STAs 106a-106d associated with the AP 104a, and that are configured to use the AP 104a for communication, can be referred to as a basic service set (BSS). In some embodiments, the wireless communication system 100 may not have a central AP 104a. For example, in some embodiments, the wireless communication system 100 can function as a peer-to-peer network between the STAs 106. Accordingly, the functions of the AP 104a described herein can alternatively be performed by one or more of the STAs 106. Moreover the AP 104a can implement one or more aspects described with respect to the STAs 106, in some embodiments.

A communication link that facilitates transmission from the AP 104a to one or more of the STAs 106 can be referred to as a downlink (DL) 130, and a communication link that facilitates transmission from one or more of the STAs 106 to the AP 104a can be referred to as an uplink (UL) 140. Alternatively, a downlink 130 can be referred to as a forward link or a forward channel, and an uplink 140 can be referred to as a reverse link or a reverse channel.

A variety of processes and methods can be used for transmissions in the wireless communication system 100 between the AP 104a and the STAs 106. In some aspects, wireless signals can be transmitted using orthogonal frequency-division multiplexing (OFDM), direct-sequence spread spectrum (DSSS) communications, a combination of OFDM and DSSS communications, or other schemes. For example, signals can be sent and received between the AP 104a and the STAs 106 in accordance with OFDM/OFDMA processes. Accordingly, the wireless communication system 100 can be referred to as an OFDM/OFDMA system. As another example, signals can be sent and received between the AP 104a and the STAs 106 in accordance with CDMA processes. Accordingly, the wireless communication system 100 can be referred to as a CDMA system.

Aspects of certain devices (such as the AP 104a and the STAs 106) implementing such protocols can consume less power than devices implementing other wireless protocols. The devices can be used to transmit wireless signals across a relatively long range, for example about one kilometer or longer. As described in greater detail herein, in some embodiments, devices can be configured to establish wireless links faster than devices implementing other wireless protocols.

### Association and Authentication

Generally, in IEEE 802.1X protocols, authentication takes place between a STA and an authentication server (e.g., a server that provides authentication services, such as identity verification, authorization, privacy, and non-repudiation). For example, the AP, which functions as an authenticator, relays messages between the AP and the authentication server during the authentication process. In some instances, the authentication messages between the STA and the AP are transported using extensible authentication protocol over local area network (EAPOL) frames. EAPOL frames may be defined in the IEEE 802.11i protocol. The authentication messages between the AP and the authentication server may be transported using the remote authentication dial in user service (RADIUS) protocol or the Diameter authentication, authorization, and accounting protocol.

During the authentication process, the authentication server may take a long time to respond to messages received from the AP. For example, the authentication server may be physically located at a location remote from the AP, so the delay may be attributed to the backhaul link speed. As another example, the authentication server may be processing a large number of authentication requests initiated by STAs and/or APs (e.g., there may be a large number of STAs in a dense area, such as on the train 120, each of which are attempting to establish a connection). Thus, the delay may be attributed to the loading (e.g., traffic) on the authentication server.

Because of the delay attributed to the authentication server, the STAs may be idle for long periods of time. However, in IEEE 802.1X protocols, association is performed before the AP initiates the authentication process. This is beneficial because once a STA is associated with an AP, a STA can enter the sleep state to conserve power. For example, a STA may need to synchronize with an AP to schedule times in which the STA is in a sleep state and times in which the STA is in an awake state (e.g., active state, state in which all components of the STA are powered on, etc.) so that the STA does not miss any packets that are intended for the STA, and the synchronization may only occur once the STA is associated with the AP. Thus, the STA may enter the sleep state and reduce power consumption while the AP waits for the authentication server to respond. In addition, because the EAPOL frames are data frames, the STA may be configured to transition from the sleep state to the awake state upon receiving an EAPOL frame from the AP that the STA is associated with. In this way, the IEEE 802.1X protocols include mechanisms to allow the STAs to conserve power, even when the authentication server provides delayed responses.

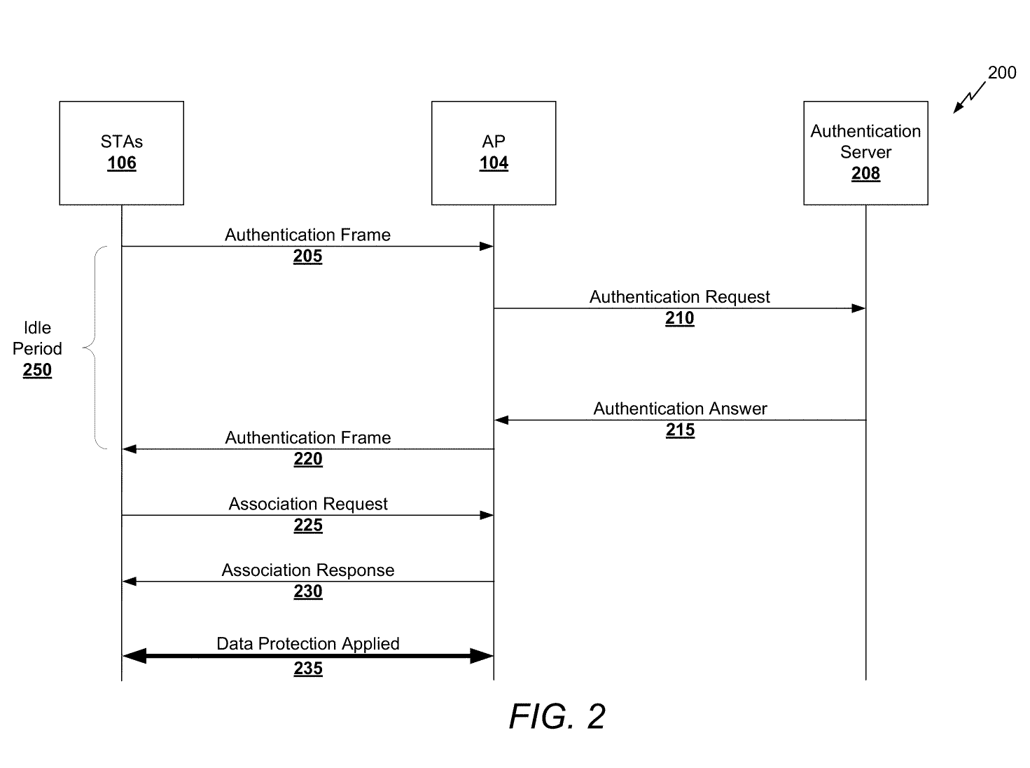

However, in order to implement FILS (e.g., in IEEE 802.11ai), the authentication mechanism was redesigned. In particular, the authentication mechanism was redesigned such that association occurs after authentication. FIG. 2 shows a communication exchange 200 in a FILS wireless communication system. Signaling is shown, according to various embodiments, between one or more STAs 106 and 106a-106d, one or more APs 104a-104b, and an authentication server 208 during authentication and association in an IEEE 802.11ai network.

As illustrated in FIG. 2, the STA 106 transmits an authentication frame 205 to the AP 104. The authentication frame 205 may be an EAPOL frame that includes an extensible authentication protocol (EAP) re-authentication initiation message (e.g., which is part of the EAP Re-authentication Protocol).

Based on receiving the authentication frame 205, the AP 104 may transmit an authentication request 210 to the authentication server 208. The authentication request 210 may be an authentication, authorization, and accounting (AAA) EAP Request (e.g., an EAP payload), which may include the EAP re-authentication initiation message.

As discussed above, the authentication server 208 may take a long period of time to respond to the authentication request 210. Once the authentication server 208 is ready to respond, the authentication server 208 may transmit an authentication answer 215 to the AP 104. The authentication answer 215 may be an AAA EAP Answer (e.g., an EAP payload), which may include an indication of whether authentication succeeded or failed. For example, the indication of whether authentication succeeded or failed may be an EAP success message or an EAP failure message. The authentication answer 215 may also include a pairwise master key (PMK), which is distributed to the AP 104 and used to encrypt traffic.

Upon receiving the authentication answer 215, the AP 104 may transmit an authentication frame 220 to the STA 106. The authentication frame 220 may be an EAPOL frame and include an EAP finish-re-authentication message (e.g., which is part of the EAP Re-authentication Protocol), which indicates whether authentication succeeded or failed.

After receiving the authentication frame 220, the STA 106 may transmit an association request 225 to the AP 104 in order to associate with the AP 104. The association request 225 may be an EAPOL frame and include a key confirmation. If association is successful, the AP 104 may respond with an association response 230. The association response 230 may be an EAPOL frame and include a key confirmation and/or a group-key distribution, which can be used to encrypt traffic. Once the STA 106 is associated with the AP 104, data protection 235 is applied for communications between the STA 106 and the AP 104.

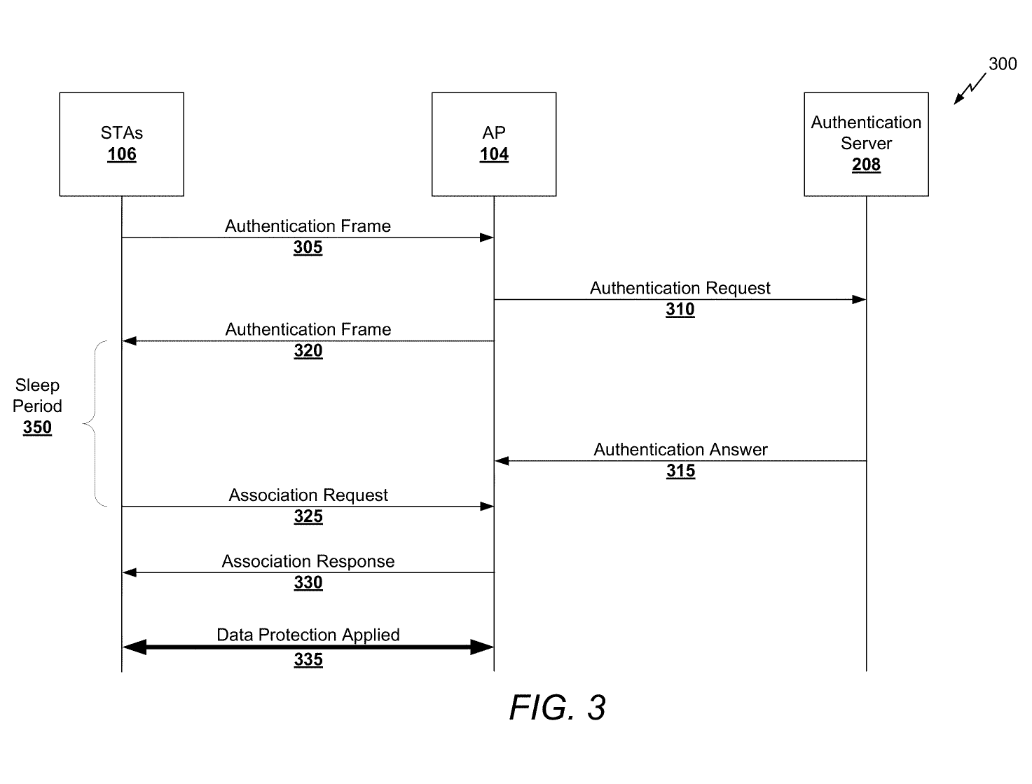

As described above, the authentication server 208 may take a long period of time to respond to the authentication request 210. In fact, the amount of time between transmission of the authentication frame 205 and reception of the authentication frame 220, represented as idle period 250, may be several target beacon transmit times (TBTTs). The idle period 250 may be considerable in a situation in which there are many FILS authentication and association requests (e.g., in dense WiFi configurations, such as in the train 120, an apartment complex, outdoor cafes, airports, etc.). However, because association with the AP 104 occurs near the end of the authentication and association process, the STA 106 cannot enter the sleep state in order to conserve power. Thus, the current IEEE 802.11ai authentication mechanism inefficiently results in the excess consumption of power. Various embodiments that may help minimize excessive consumption of power are disclosed below with respect to FIGS. 3-5.

FIG. 3 shows an exemplary communication exchange 300 in the wireless communication system 100 of FIG. 1. As with FIG. 2, signaling is shown, according to various embodiments, between one or more STAs 106 and 106a-106d, one or more APs 104a-104b, and the authentication server 208 during the authentication and association process.

As in the communication exchange 200 illustrated in FIG. 2, the communication exchange 300 includes an authentication frame 305 transmitted from the STA 106 to the AP 104, an authentication request 310 transmitted from the AP 104 to the authentication server 208 in response to the AP 104 receiving the authentication frame 305, and an authentication frame 320 transmitting from the AP 104 to the STA 106.

In an embodiment, the authentication frame 305 (e.g., an EAPOL frame) includes an extensible authentication protocol (EAP) re-authentication initiation message (e.g., which is part of the EAP Re-authentication Protocol) and a STA 106 nonce value (e.g., SNonce). In some embodiments, the authentication frame 305 includes a message indicating a request for a power-save operation. This request for the power-save operation may result in the AP 104 providing a response delay estimate, which is described below. The authentication request 310 may be an AAA EAP Request (e.g., an EAP payload), which may include the EAP re-authentication initiation message. In another embodiment, the STA 106 may include the maximum time that the STA 106 is willing to wait. This maximum time may be used by the AP 104 to determine whether it should initiate a response (e.g., authentication frame 320) immediately or not. If the AP 104 expects the authentication answer 315, described below, to reach the AP 104 before the maximum time, then the AP 104 may consider waiting. If the AP 104 does not expect the authentication answer 315 to reach the AP 104 before the maximum time, then the AP 104 may send the response (e.g., authentications frame 320) immediately, indicating the response delay estimate.

In an embodiment, unlike the authentication frame 220, the authentication frame 320 (e.g., an EAPOL frame) includes a response delay estimate and an AP 104 nonce value (e.g., ANonce). The response delay estimate may be determined or calculated by the AP 104. The response delay estimate may be an estimate of the amount of time that the AP 104 expects to pass before the authentication server 208 responds to the authentication request 310 and/or an estimate of the time that the AP 104 expects the authentication server 208 to respond to the authentication request 310. The response delay estimate may be determined or calculated based on heuristics, such as previous response times by the authentication server 208 (e.g., the amount of time it took the authentication server 208 to respond to authentication requests in the past), a set time determined by the AP 104, a load of the authentication server 208 (e.g., how much traffic is being handled by the authentication server 208), and/or a combination of one or more of the factors described herein.

Because the STA 106 is provided with an estimate of when the STA 106 can expect to receive information on whether authentication succeeded or failed, the STA 106 may transition from the awake state to the sleep state (e.g., controlled by a power save controller of the STA 106) after receiving the authentication frame 320 even though association has not taken place yet. The amount of time that the STA 106 is in the sleep state may be based on the response delay estimate (e.g., the time may be equal to or nearly equal to the sleep period 350). In this way, the STA 106 may be able to conserve power while waiting for the authentication server 208 to respond.

After the sleep period 350 has passed, the STA 106 may transition from the sleep state to the active state (e.g., controlled by the power save controller of the STA 106) and transmit an association request 325 to the AP 104 (e.g., the STA 106 delays transmission of the association request 325 for a time period based on the response delay estimate). The association request 325 may be an EAPOL frame and include a key confirmation.

Before or after (not shown) the AP 104 receives the association request 325, the AP 104 may receive an authentication answer 315 from the authentication server 208. The authentication answer 315 may be an AAA EAP Answer (e.g., an EAP payload), which may include an indication of whether authentication succeeded or failed. For example, the indication of whether authentication succeeded or failed may be an EAP success message or an EAP failure message. The authentication answer 315 may also include a PMK.

Once the AP 104 has received both the association request 325 and the authentication answer 315, the AP 104 may transmit an association response 330 to the STA 106 if authentication and association are successful. The association response 330 may be an EAPOL frame and include a key confirmation and/or a group-key distribution, which can be used to encrypt traffic. In an embodiment, the association response 330 also indicates whether authentication succeeded or failed (e.g., the EAP finish-re-authentication message, which is part of the EAP Re-authentication Protocol). Thus, the association response 330 may not only include information provided when association is completed, but may also indicate whether authentication was successful. In previous implementations, the EAP finish-re-authentication message was included in the authentication frame 220. However, since the EAP finish-re-authentication message is not used by the STA 106 when generating the association request 325, transmission of the EAP finish-re-authentication message may be delayed. In this way, the signaling of the existing IEEE 802.11ai authentication and association process is maintained, yet the STAs 106 are able to conserve power while waiting for the authentication server 208 to respond. In an embodiment, if the authentication answer 315 arrives at the AP 104 after the AP 104 receives the association request 325, then the AP 104 sends an association comeback to the STA 106 (e.g., a message requesting the STA 106 to try associating again at a later time).

In an embodiment, if association and/or authentication are not successful, the AP 104 may respond with no message, with a message indicating that association and/or authentication failed, and/or with a disassociation frame (not shown). Once the STA 106 is associated with the AP 104, data protection 335 is applied for communications between the STA 106 and the AP 104.

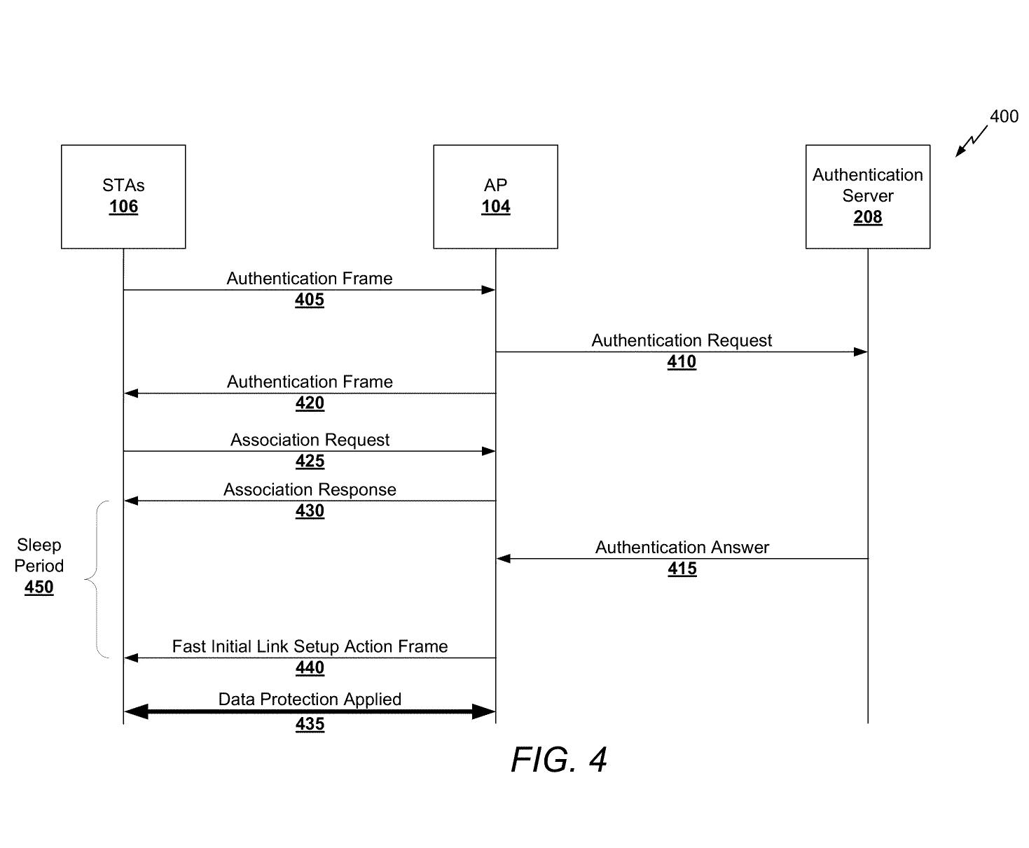

FIG. 4 shows another exemplary communication exchange 400 in the wireless communication system 100 of FIG. 1. As with FIGS. 2 and 3, signaling is shown, according to various embodiments, between one or more STAs 106 and 106a-106d, one or more APs 104a-104b, and the authentication server 208 during the authentication and association process.

As in the communication exchanges 200 illustrated in FIGS. 2 and 300 illustrated in FIG. 3, the communication exchange 400 includes an authentication frame 405 transmitted from the STA 106 to the AP 104, an authentication request 410 transmitted from the AP 104 to the authentication server 208 in response to the AP 104 receiving the authentication frame 405, and an authentication frame 420 transmitting from the AP 104 to the STA 106.

In an embodiment, the authentication frame 405 (e.g., an EAPOL frame) includes an extensible authentication protocol (EAP) re-authentication initiation message (e.g., which is part of the EAP Re-authentication Protocol) and a STA 106 nonce value (e.g., SNonce). In some embodiments, the authentication frame 405 includes a message indicating a request for a power-save operation. This request for the power-save operation may result in the AP 104 providing an authentication pending message, which is described below. The authentication request 410 may be an AAA EAP Request (e.g., an EAP payload), which may include the EAP re-authentication initiation message.

In an embodiment, the authentication frame 420 (e.g., an EAPOL frame) includes an AP 104 nonce value (e.g., ANonce). The authentication frame 420 may also include a field to indicate that the authentication response is pending. Following reception of the authentication frame 420, the STA 106 transmits an association request 425 to the AP 104. The association request 425 may be an EAPOL frame and include a key confirmation. As described above, the STA 106 may generate and transmit the association request 425 without first receiving the EAP finish-re-authentication message because the EAP finish-re-authentication message is not used by the STA 106 when generating the association request 425.

In an embodiment, after the AP 104 receives the association request 425, the AP 104 transmits an association response 430 to the STA 106. Unlike the association responses 230 and 330, the association response 430 may not include the key confirmation if the authentication answer 415 is not yet received by the AP 104. Rather, the association response 430 may include an authentication pending message that indicates that success or failure of the authentication with the authentication server 208 is pending. Note that introduction of the authentication pending message may result in the introduction of a new state in the 802.11 WiFi stack state machine (e.g., an authentication pending state).

In an embodiment, upon receiving the association response 430, the STA 106 transitions from the awake state to the sleep state (e.g., controlled by a power save controller of the STA 106) even though association is not complete (e.g., since the STA 106 has not received the key confirmation or group-key distribution). The amount of time that the STA 106 is in the sleep state may be based on the response delay estimate described above (e.g., which may be calculated by the STA 106 or the AP 104) and represented as sleep period 450. During the power save mode (e.g., during the sleep state or mode), the STA 106 may wake up periodically to monitor beacons transmitted by the AP 104. When the AP 104 is ready with the authentication data, then the AP 104 may page the STA 106 using traffic indication bits (TIM) of the beacon. Alternatively, the STA 106 may remain in the sleep state until receiving another message from the AP 104. In this way, the STA 106 may be able to conserve power while waiting for the authentication server 208 to respond to the AP 104.

After the sleep period 450 has passed, the STA 106 may transition from the sleep state to the active state (e.g., controlled by the power save controller of the STA 106). The STA 106 may transition to the active state automatically after the sleep period 450 has passed or after receiving a message from the AP 104. For example, the STA 106 may transition to the awake state upon receiving a FILS action frame 440 from the AP 104.

In an embodiment, whether the STA 106 transitions to the active state automatically or after receiving a message, the AP 104 transmits the FILS action frame 440 after the AP 104 receives the authentication answer 415 from the authentication server 208. The authentication answer 415 may be an AAA EAP Answer (e.g., an EAP payload), which may include an indication of whether authentication succeeded or failed. For example, the indication of whether authentication succeeded or failed may be an EAP success message or an EAP failure message. The authentication answer 415 may also include a PMK.

In an embodiment, the FILS action frame 440 includes a key confirmation, a group-key distribution, and/or an indication of whether authentication succeeded or failed (e.g., the EAP finish-re-authentication message, which is part of the EAP Re-authentication Protocol). Thus, the FILS action frame 440 may include information provided when association is completed and also indicate whether authentication was successful. In an alternative embodiment, the AP 104 transmits an EAPOL frame instead of a FILS action frame and includes the same information in the EAPOL frame as in the FILS action frame. In this way, the STAs 106 are able to conserve power while waiting for the authentication server 208 to respond.

Upon transmission of the FILS action frame 440 by the AP 104 and/or reception of the FILS action frame 440 by the STA 106, the authenticator (e.g., the AP 104) may enable (e.g., open) the controlled port, which allows network traffic to be transmitted by and received by the STA 106.

In an embodiment, if association and/or authentication are not successful, instead of the FILS action frame 440, the AP 104 may respond with no message, with a message indicating that association and/or authentication failed, and/or with a disassociation frame (not shown). Once the STA 106 is associated with the AP 104, data protection 435 is applied for communications between the STA 106 and the AP 104.

In some embodiments, the AP 104 will broadcast a beacon message, advertising a wireless network managed by the AP 104. The AP 104 can periodically transmit the beacon, which can include information on how the STAs 106 can communicate with the AP 104 and the capabilities of the AP 104. The capabilities of the AP 104 may include a FILS association power save mode, which includes the power save mechanisms described herein with respect to FIG. 3 (e.g., use of the response delay estimate) and/or FIG. 4 (e.g., use of the authentication pending message).

In other embodiments, the STAs 106 request information about the wireless network managed by the AP 104 by transmitting probe requests. The STAs 106 can transmit one or more probe requests, for example, when they have not yet seen a beacon, to obtain additional information about the AP 104, and/or to determine which APs are in range.

The AP 104 can respond to one or more probe requests with one or more probe responses. The probe responses may include, for example, information on how the STAs 106 can communicate with the AP 104 and the capabilities of the AP 104. The capabilities of the AP 104 may include a FILS association power save mode, which includes the power save mechanisms described herein with respect to FIG. 3 (e.g., use of the response delay estimate) and/or FIG. 4 (e.g., use of the authentication pending message).

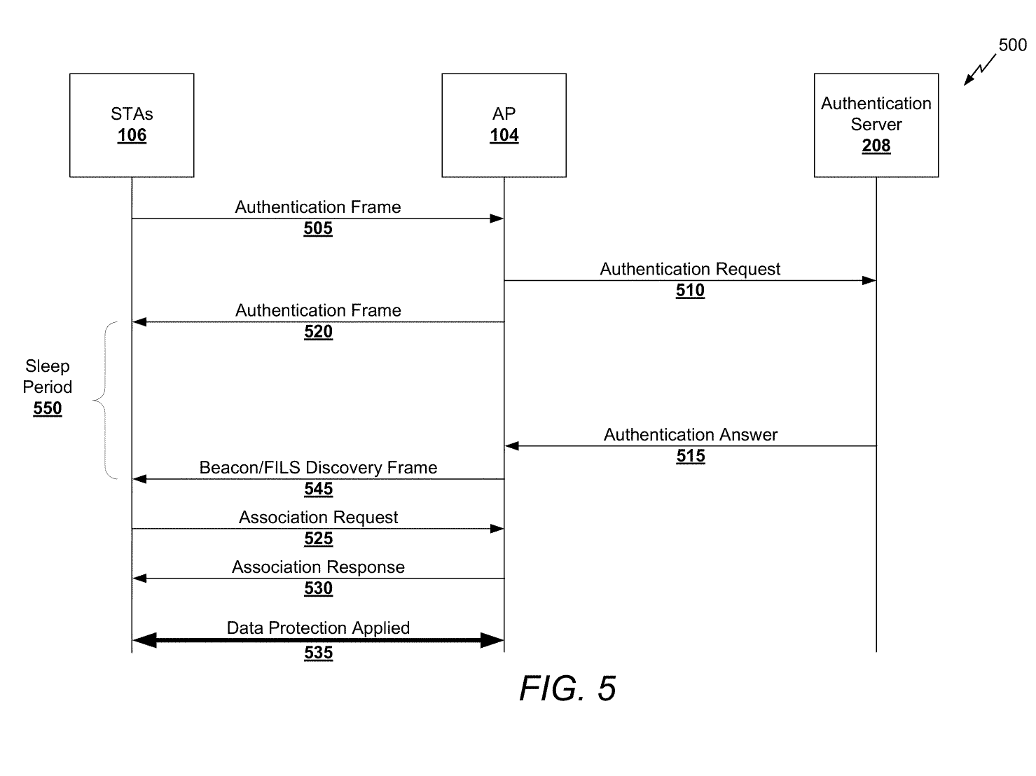

FIG. 5 shows another exemplary communication exchange 500 in the wireless communication system 100 of FIG. 1. As with FIGS. 2-4, signaling is shown, according to various embodiments, between one or more STAs 106 and 106a-106d, one or more APs 104a-104b, and the authentication server 208 during the authentication and association process.

As in the communication exchanges 200 illustrated in FIG. 2, 300 illustrated in FIGS. 3, and 400 illustrated in FIG. 4, the communication exchange 500 includes an authentication frame 505 transmitted from the STA 106 to the AP 104, an authentication request 510 transmitted from the AP 104 to the authentication server 208 in response to the AP 104 receiving the authentication frame 505, and an authentication frame 520 transmitting from the AP 104 to the STA 106.

In an embodiment, the authentication frame 505 (e.g., an EAPOL frame) includes an extensible authentication protocol (EAP) re-authentication initiation message and a STA 106 nonce value (e.g., SNonce). In some embodiments, the authentication frame 505 includes a message indicating a request for a power-save operation. This request for the power-save operation may result in the AP 104 providing an authentication pending message, which is described below. The authentication request 510 may be an AAA EAP Request (e.g., an EAP payload), which may include the EAP re-authentication initiation message.

In an embodiment, the authentication frame 520 (e.g., an EAPOL frame) includes a temporary association identifier (ID). The temporary association ID may allow the STA 106 to function as if the STA 106 is associated with the AP 104. Thus, the STA 106 may be able to enter the sleep state once the authentication frame 520 is received. In some embodiments, the regular association ID received when the STA 106 actually associates with the AP 104 may be the same as the temporary association ID. The authentication frame 520 may also include an AP 104 nonce value (e.g., ANonce). Additionally, the authentication frame 520 may also include the periodicity or the wake-up intervals, where the AP 104 broadcasts a beacon and/or a FILS discovery frame as described below.

After receiving the authentication frame 520, the STA 106 transitions from the active state to the sleep state. The STA 106 may periodically wake up (e.g., transition back to the active state) to see if the STA 106 is being paged by the AP 104 (e.g., if a beacon/FILS discovery frame is transmitted by the AP 104, as described below). The periodicity or offset by which the AP 104 will page the STA 106 (e.g., transmit the beacon/FILS discovery frame) may be indicated in the authentication frame 520. The STA 106 may be in the sleep state (and periodically wake up) for a period defined by sleep period 550.

The AP 104 may transmit a beacon/FILS discovery frame 545 after the AP 104 receives the authentication answer 515 from the authentication server 208. The authentication answer 515 may be an AAA EAP Answer (e.g., an EAP payload), which may include an indication of whether authentication succeeded or failed. For example, the indication of whether authentication succeeded or failed may be an EAP success message or an EAP failure message. The authentication answer 515 may also include a PMK.

The beacon/FILS discovery frame 545 may include the temporary association ID so that the STA 106 understands that the frame 545 is addressed to the STA 106. After receiving the beacon/FILS discovery frame 545, the STA 106 may transition from the sleep state to the active state because the STA 106 knows that the authentication answer 515 has been received by the AP 104 from the authentication server 208. The STA 106 may send an association request 525, described below, in response to the reception of a beacon that includes the TIM corresponding to the association ID. In some embodiments, the beacon/FILS discovery frame 545 is transmitted (e.g., broadcasted) more often than normal beacons to minimize any delay in association. For example, delay may occur if the authentication answer 515 is received immediately after a period to transmit the beacon/FILS discovery frame 545 has passed. The authentication frame 520 may indicate that beacon/FILS discovery frames will be transmitted at a faster rate so that the STA 106 wakes up periodically from the sleep state more often (e.g., and thus the period to transmit the beacon/FILS discovery frame 545 will come sooner).

Following reception of the beacon/FILS discovery frame 545, the STA 106 transmits an association request 525 to the AP 104. The association request 525 may be an EAPOL frame and include a key confirmation. As described above, the STA 106 may generate and transmit the association request 525 without first receiving the EAP finish-re-authentication message because the EAP finish-re-authentication message is not used by the STA 106 when generating the association request 525.

In an embodiment, after the AP 104 receives the association request 525, the AP 104 transmits an association response 530 to the STA 106. Like the association response 330, the association response 530 may be an EAPOL frame and include a key confirmation and/or a group-key distribution, which can be used to encrypt traffic. In an embodiment, the association response 530 also indicates whether authentication succeeded or failed (e.g., the EAP finish-re-authentication message, which is part of the EAP Re-authentication Protocol). Thus, the association response 530 may not only include information provided when association is completed, but may also indicate whether authentication was successful. In this way, the signaling of the existing IEEE 802.11ai authentication and association process is maintained, yet the STAs 106 are able to conserve power while waiting for the authentication server 208 to respond.

In an embodiment, if association and/or authentication are not successful, the AP 104 may respond with no message, with a message indicating that association and/or authentication failed, and/or with a disassociation frame (not shown). Once the STA 106 is associated with the AP 104, data protection 535 is applied for communications between the STA 106 and the AP 104.

Components of an AP and/or STA

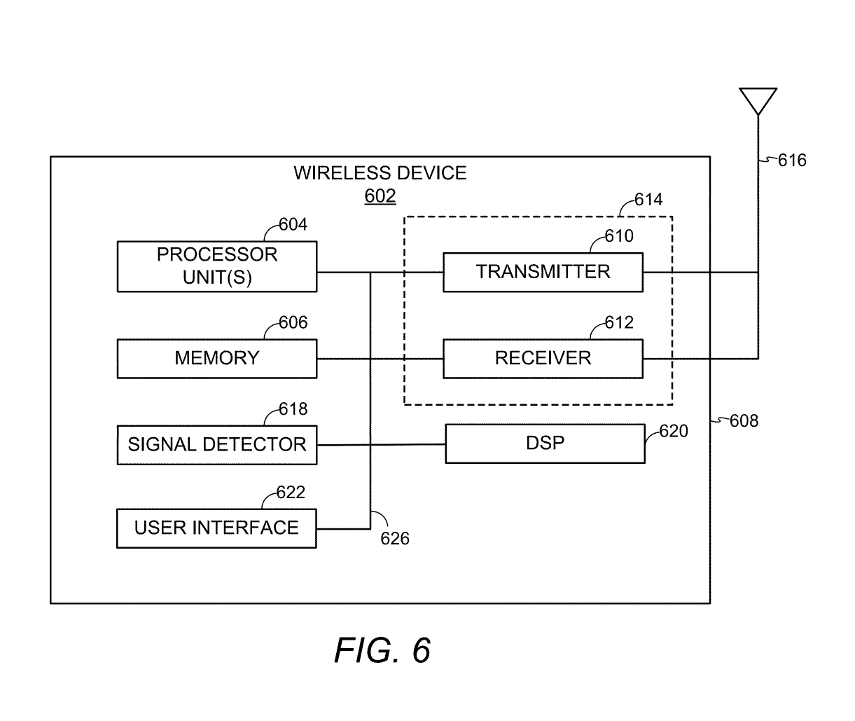

FIG. 6 shows a functional block diagram of an exemplary a wireless device 602 that can be employed within the wireless communication system 100 of FIG. 1. The wireless device 602 is an example of a device that can be configured to implement the various methods described herein. For example, the wireless device 602 can include the AP 104 and/or one of the STAs 106.

The wireless device 602 can include one or more processor units 604 which are configured to control operation of the wireless device 602. One or more of the processor units 604 can be collectively referred to as a central processing unit (CPU). A memory 606, which can include both read-only memory (ROM) and random access memory (RAM), provides instructions and data to the processor units 604. A portion of the memory 606 can also include non-volatile random access memory (NVRAM). The processor units 604 can be configured to perform logical and arithmetic operations based on program instructions stored within the memory 606. The processor 604 can be configured to implement one or more methods described herein, for example in conjunction with executable instructions in the memory 606.

When the wireless device 602 is implemented or used as an AP, the processor 604 can be configured to expedite the discovery of the AP by a STA and the creation of a link with a STA. The processor 604 can be further configured to reduce contention for AP resources. For example, a high volume of STAs requesting access can cause packet collisions or dropping of packets. Various processes to expedite connection and improve resource utilization are described in further detail herein.

When the wireless device 602 is implemented or used as a STA, the processor units 604 can be configured to expedite the discovery of an AP and the creation of a link with the AP. The processor units 604 can be further configured to reduce contention for AP resources. For example, through passive listening, a STA can acquire the information needed to establish a link with an AP without directly requesting the information from the AP. This and various other processes to expedite connection and improve resource utilization are described in further detail below.

The processor units 604 can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. In an implementation where the processor units 604 include a DSP, the DSP can be configured to generate a packet (e.g., a data packet) for transmission. In some aspects, the packet can include a physical layer data unit (PPDU).

The wireless device 602 can also include machine-readable media for storing software. The processing units 604 can include one or more machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the processor units 604, cause the wireless device 602 to perform the various functions described herein.

The wireless device 602 can include a transmitter 610 and/or a receiver 612 to allow transmission and reception, respectively, of data between the wireless device 602 and a remote location. The transmitter 610 and receiver 612 can be combined into a transceiver 614. An antenna 616 can be attached to the housing 608 and electrically coupled with the transceiver 614. The wireless device 602 can also include (not shown) multiple transmitters, multiple receivers, multiple transceivers, and/or multiple antennas.

The transmitter 610 can be configured to wirelessly transmit packets and/or signals. For example, the transmitter 610 can be configured to transmit different types of packets generated by the processor units 604, discussed above. The packets are made available to the transmitter 610. For example, the processor units 604 can store a packet in the memory 606 and the transmitter 610 can be configured to retrieve the packet. Once the transmitter retrieves the packet, the transmitter 610 transmits the packet to a STA 106 wireless device 602 via the antenna 616.

An antenna 616 on the STA 106 wireless device 602 detects wirelessly transmitted packets/signals. The STA 106 receiver 612 can be configured to process the detected packets/signals and make them available to the processor units 604. For example, the STA 106 receiver 612 can store the packet in memory 606 and the processor units 604 can be configured to retrieve the packet.

The wireless device 602 can also include a signal detector 618 that can be used in an effort to detect and quantify the level of signals received by the transceiver 614. The signal detector 618 can detect such signals as total energy, energy per subcarrier per symbol, power spectral density, and other signals. The wireless device 602 can also include a digital signal processor (DSP) 620 for use in processing signals. The DSP 620 can be configured to generate a packet for transmission. In some aspects, the packet can include a physical layer data unit (PPDU).

The wireless device 602 can further include a user interface 622 in some aspects. The user interface 622 can include a keypad, a microphone, a speaker, and/or a display. The user interface 622 can include any element or component that conveys information to a user of the wireless device 602 and/or receives input from the user. The wireless device 602 can also include a housing 608 surrounding one or more of the components included in the wireless device 602.

The various components of the wireless device 602 can be coupled together by a bus system 626. The bus system 626 can include a data bus, for example, as well as a power bus, a control signal bus, and a status signal bus in addition to the data bus. Those of skill in the art will appreciate the components of the wireless device 602 can be coupled together or accept or provide inputs to each other using some other mechanism.

Although a number of separate components are illustrated in FIG. 6, those of skill in the art will recognize that one or more of the components can be combined or commonly implemented. For example, the processor units 604 can be used to implement not only the functionality described above with respect to the processor units 604, but also to implement the functionality described above with respect to the signal detector 618. Further, each of the components illustrated in FIG. 6 can be implemented using a plurality of separate elements.

### Flowcharts

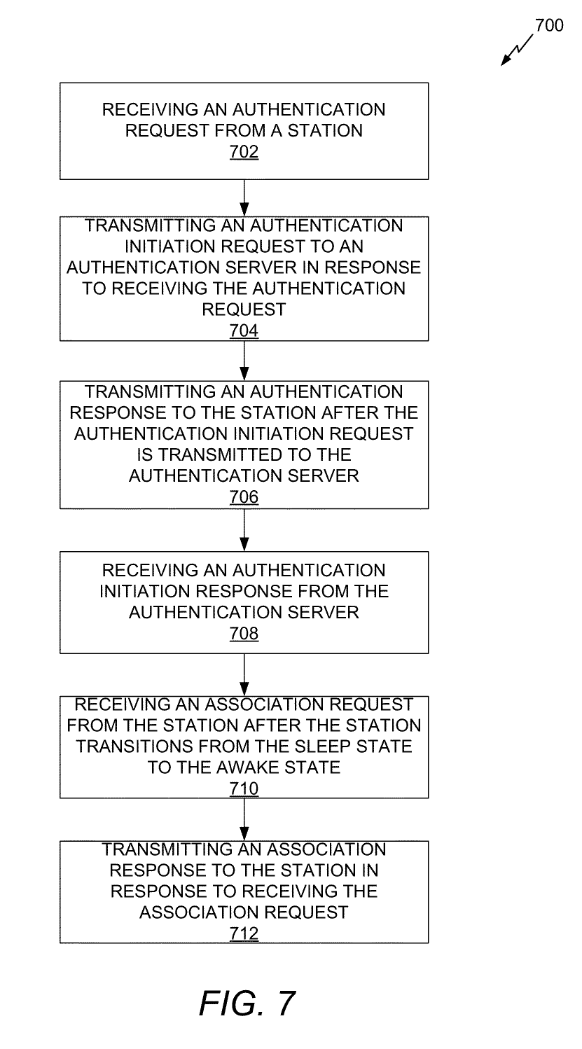

FIG. 7 is a flowchart of a process 700 for communicating data in the wireless communications system of FIG. 1. In an embodiment, the process 700 may be performed by an AP, such as the AP 104. At block 702, the process 700 receives an authentication request from a STA. At block 704, the process 700 transmits an authentication initiation request to an authentication server in response to receiving the authentication request.

At block 706, the process 700 transmits an authentication response to the STA after the authentication initiation request is transmitted to the authentication server. In an embodiment, the authentication response comprises an estimated response delay. In a further embodiment, the STA transitions from an awake state to a sleep state in response to receiving the authentication response for a duration of time based on the estimated response delay.

At block 708, the process 700 receives an authentication initiation response from the authentication server. In an embodiment, the authentication initiation response comprises an authentication status that indicates whether authentication with the authentication server is successful. At block 710, the process 700 receives an association request from the STA after the STA transitions from the sleep state to the awake state. At block 712, the process 700 transmits an association response to the STA in response to receiving the association request. In an embodiment, the association response comprises the authentication status. After block 712, the process 700 ends.

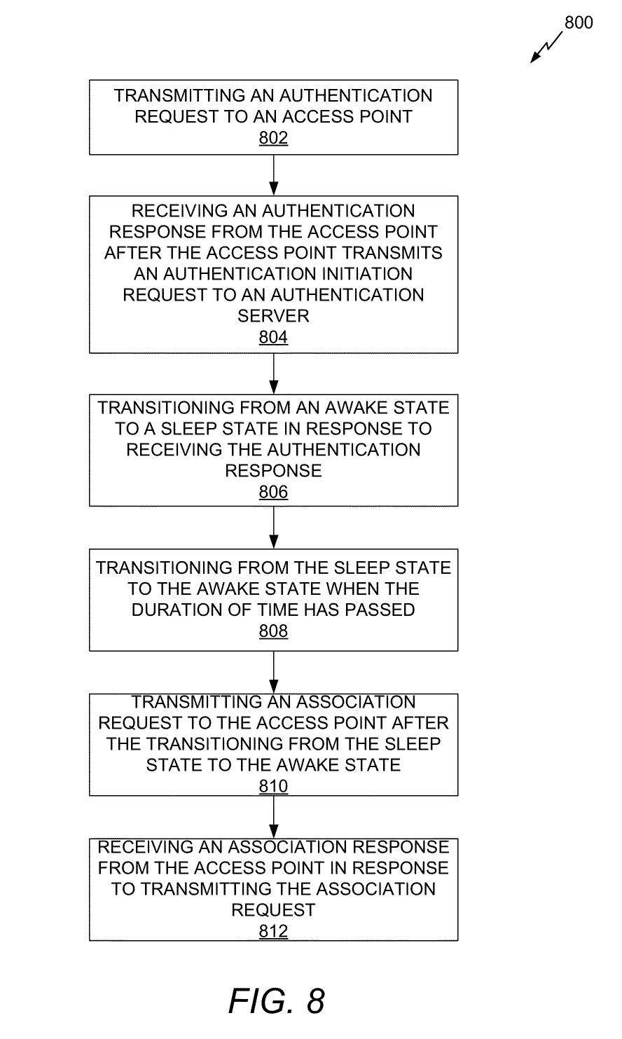

FIG. 8 is a flowchart of a process 800 for communicating data in the wireless communications system of FIG. 1. In an embodiment, the process 800 may be performed by a STA, such as the STA 106. At block 802, the process 800 transmits an authentication request to an AP. At block 804, the process 800 receives an authentication response from the AP after the AP transmits an authentication initiation request to an authentication server. In an embodiment, the authentication response comprises an estimated response delay.

At block 806, the process 800 transitions from an awake state to a sleep state in response to receiving the authentication response for a duration of time based on the estimated response delay. At block 808, the process 800 transitions from the sleep state to the awake state when the duration of time has passed.

At block 810, the process 800 transmits an association request to the AP after the transitioning from the sleep state to the awake state. At block 812, the process 800 receives an association response from the AP in response to transmitting the association request. In an embodiment, the association response comprises an authentication status received by the AP from the authentication server. In a further embodiment, the authentication status indicates whether authentication with the authentication server is successful. After block 812, the process 800 ends.

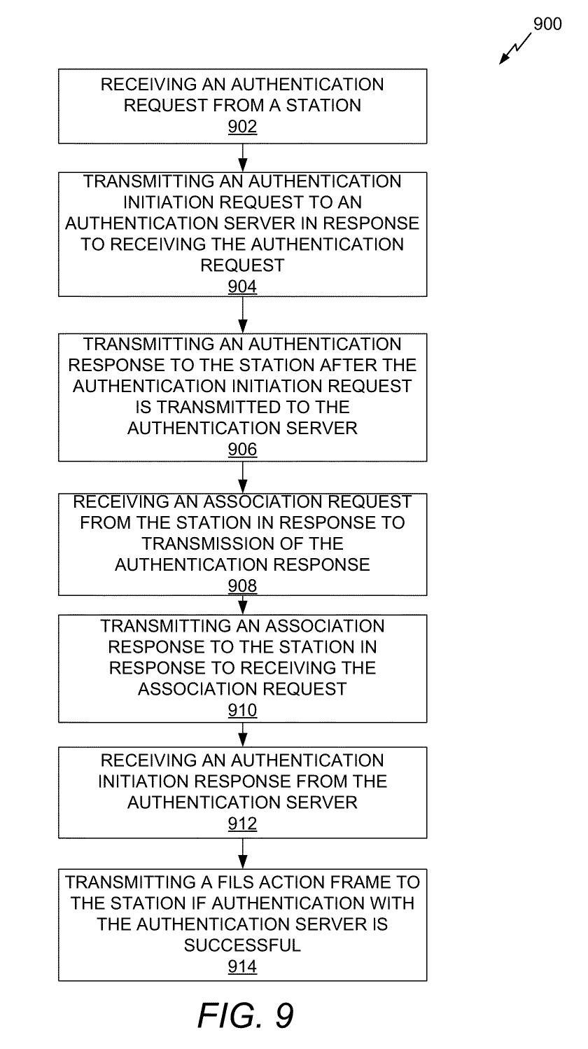

FIG. 9 is a flowchart of a process 900 for communicating data in the wireless communications system of FIG. 1. In an embodiment, the process 900 may be performed by an AP, such as the AP 104. At block 902, the process 900 receives an authentication request from a STA. At block 904, the process 900 transmits an authentication initiation request to an authentication server in response to receiving the authentication request.

At block 906, the process 900 transmits an authentication response to the STA after the authentication initiation request is transmitted to the authentication server. At block 908, the process 900 receives an association request from the STA in response to transmission of the authentication response. At block 910, the process 900 transmits an association response to the STA in response to receiving the association request. In an embodiment, the association response comprises an authentication pending message that indicates that authentication with the authentication server is pending. In a further embodiment, the STA transitions from an awake state to a sleep state in response to receiving the association response.

At block 912, the process 900 receives an authentication initiation response from the authentication server. In an embodiment, the authentication initiation response comprises an authentication status that indicates whether authentication with the authentication server is successful. At block 914, the process 900 transmits a FILS action frame to the STA if authentication with the authentication server is successful. In an embodiment, the FILS action frame comprises a key confirmation, a group-key distribution, and the authentication status. After block 914, the process 900 ends.

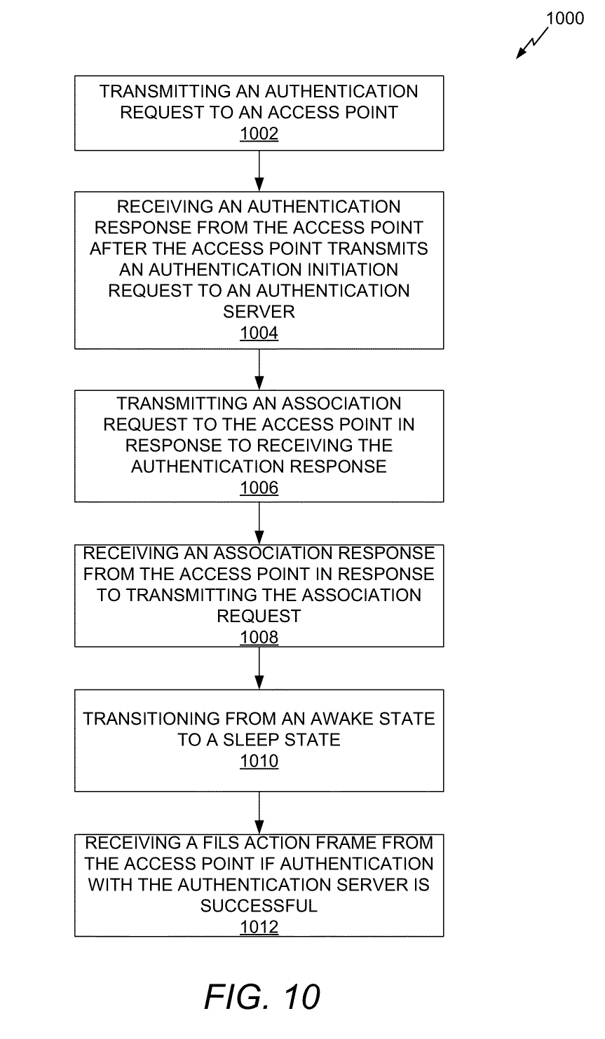

FIG. 10 is a flowchart of a process 1000 for communicating data in the wireless communications system of FIG. 1. In an embodiment, the process 1000 may be performed by a STA, such as the STA 106. At block 1002, the process 1000 transmits an authentication request to an AP. At block 1004, the process 1000 receives an authentication response from the AP after the AP transmits an authentication initiation request to an authentication server.

At block 1006, the process 1000 transmits an association request to the AP in response to receiving the authentication response. At block 1008, the process 1000 receives an association response from the AP in response to transmitting the association request. In an embodiment, the association response comprises an authentication pending message that indicates that authentication with the authentication server is pending.

At block 1010, the process 1000 transitions from an awake state to a sleep state in response to receiving the association response. At block 1012, the process 1000 receives a FILS action frame from the AP if authentication with the authentication server is successful. In an embodiment, the FILS action frame comprises a key confirmation, a group-key distribution, and an authentication status that indicates whether authentication with the authentication server is successful. After block 1012, the process 1000 ends.

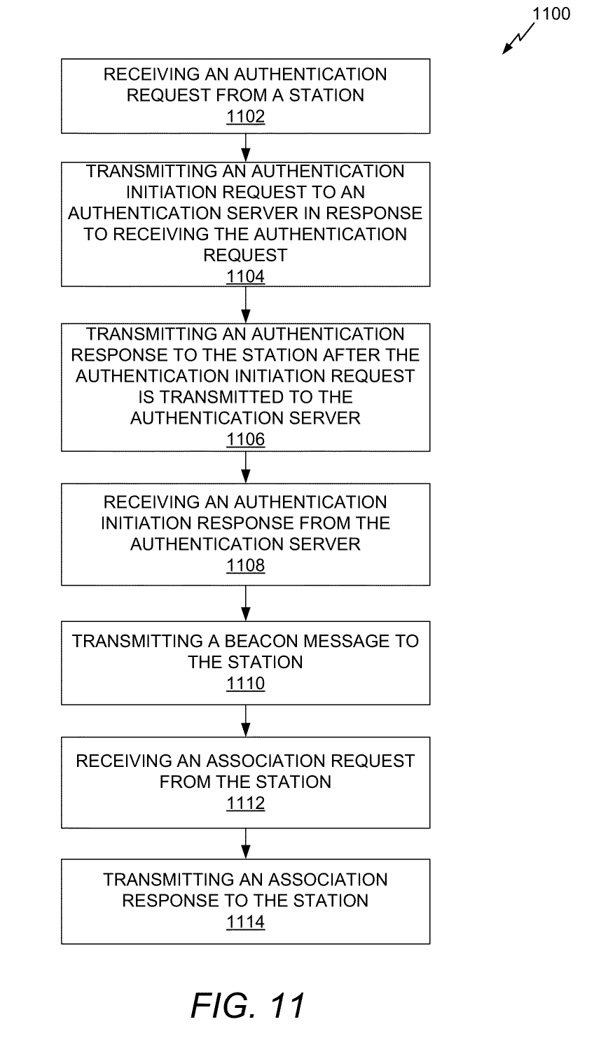

FIG. 11 is a flowchart of a process 1100 for communicating data in the wireless communications system of FIG. 1. In an embodiment, the process 1100 may be performed by an AP, such as the AP 104. At block 1102, the process 1100 receives an authentication request from a STA. At block 1104, the process 1100 transmits an authentication initiation request to an authentication server in response to receiving the authentication request.

At block 1106, the process 1100 transmits an authentication response to the STA after the authentication initiation request is transmitted to the authentication server. In an embodiment, the authentication response comprises a temporary association identification. In a further embodiment, the station transitions from an awake state to a sleep state in response to receiving the authentication response. At block 1108, the process 1100 receives an authentication initiation response from the authentication server. In an embodiment, the authentication initiation response comprises an authentication status that indicates whether authentication with the authentication server is successful.

At block 1110, the process 1100 transmits a beacon message to the STA in response to receiving the authentication initiate response. At block 1112, the process 1100 receives an association request from the STA in response to transmission of the beacon message. At block 1114, the process 1100 transmits an association response to the STA in response to receiving the association request. In an embodiment, the association response comprises the authentication status. After block 1114, the process 1100 ends.

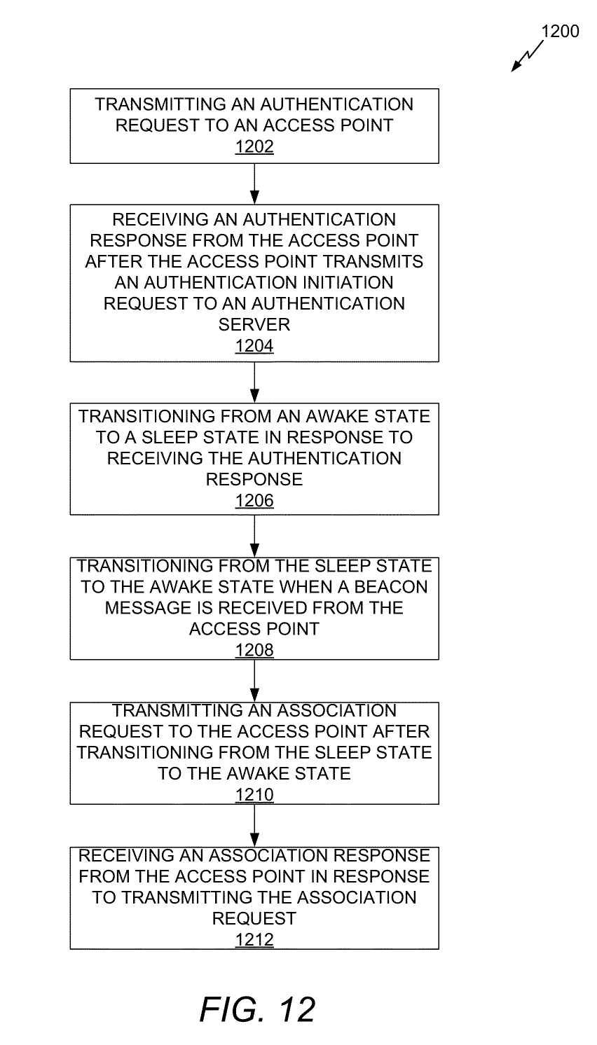

FIG. 12 is a flowchart of a process 1200 for communicating data in the wireless communications system of FIG. 1. In an embodiment, the process 1200 may be performed by a STA, such as the STA 106. At block 1202, the process 1200 transmits an authentication request to an AP. At block 1204, the process 1200 receives an authentication response from the AP after the AP transmits an authentication initiation request to an authentication server. In an embodiment, the authentication response comprises a temporary association identification.

At block 1206, the process 1200 transitions from an awake state to a sleep state in response to receiving the authentication response. At block 1208, the process 1200 transitions from the sleep state to the awake state when a beacon message is received from the AP.

At block 1210, the process 1200 transmits an association request to the AP after the transitioning from the sleep state to the awake state. At block 1212, the process 1200 receives an association response from the AP in response to transmitting the associating request. In an embodiment, the association response comprises an authentication status received by the AP from the authentication server. In a further embodiment, the authentication status indicates whether authentication with the authentication server is successful. After block 1212, the process 1200 ends.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for communicating data in a wireless communications network, comprising:
transmitting an authentication request to an access point and for the access point to transmit an authentication initiation request to an authentication server;
receiving an authentication response comprising an estimated response delay from the access point;
transitioning from an awake state to a sleep state in response to receiving the authentication response for a duration of time based on the estimated response delay;
transmitting an association request to the access point after the duration of time and transitioning from the sleep state to the awake state; and
receiving an association response from the access point in response to transmitting the association request, the association response comprising an authentication status received by the access point from the authentication server, and the authentication status indicating whether authentication with the authentication server is successful.

2. The method of claim 1, the receiving an authentication response further comprising receiving the authentication response after the access point transmits the authentication initiation request to the authentication server.

3. The method of claim 1, the access point determining the estimated response delay based on at least one of a duration of time that the authentication server took to respond to a previous authentication initiation request transmitted to the authentication server at a time before transmission of the authentication initiation request, a set value, a load of the authentication server, or a combination thereof

4. The method of claim 1, the authentication status comprising at least one of an extensible authentication protocol (EAP) success message or an EAP failure message.

5. The method of claim 1, the authentication initiation request being an extensible authentication protocol (EAP) request.

6. The method of claim 1, the authentication request further comprising a request for a power-save operation, and wherein the estimated response delay is received in response to transmission of the request for the power-save operation.

7. The method of claim 1, the transmitting an authentication request further comprising transmitting a request to initiate authentication with the authentication server.

8. The method of claim 1, the association response further comprising a key confirmation and a group-key distribution.

9. The method of claim 1, further comprising receiving a beacon message periodically from the access point, the beacon message comprising information on how a station can communicate with the access point and capabilities of the access point, and capabilities of the access point comprising a fast initial link setup association power save mode that allows the station to transition into the sleep state in response to receiving the authentication response.

10. The method of claim 1, further comprising:
transmitting a probe request to the access point, the probe request comprising a request for information related to a wireless network managed by the access point; and
receiving a probe response from the access point, the probe response comprising information on how a station can communicate with the access point and capabilities of the access point, and capabilities of the access point comprising a fast initial link setup association power save mode that allows the station to transition into the sleep state in response to receiving the authentication response.

11. An apparatus for communicating data in a wireless communications network, comprising:
means for transmitting an authentication request to an access point and for the access point to transmit an authentication initiation request to an authentication server;
means for receiving an authentication response comprising an estimated response delay from the access point;
means for transitioning from an awake state to a sleep state in response to receiving the authentication response for a duration of time based on the estimated response delay;
means for transmitting an association request to the access point after the duration of time and transitioning from the sleep state to the awake state; and
means for receiving an association response from the access point in response to transmitting the association request, the association response comprising an authentication status received by the access point from the authentication server, and the authentication status indicating whether authentication with the authentication server is successful.

12. The apparatus of claim 11, the means for receiving an authentication response further comprising means for receiving the authentication response after the access point transmits the authentication initiation request to the authentication server.

13. The apparatus of claim 11, the access point determining the estimated response delay based on at least one of a duration of time that the authentication server took to respond to a previous authentication initiation request transmitted to the authentication server at a time before transmission of the authentication initiation request, a set value, a load of the authentication server, or a combination thereof

14. The apparatus of claim 11, the authentication status comprising at least one of an extensible authentication protocol (EAP) success message or an EAP failure message.

15. The apparatus of claim 11, the authentication request further comprising a request for a power-save operation, and wherein the estimated response delay is received in response to transmission of the request for the power-save operation.

16. The apparatus of claim 11, the means for transmitting an authentication request further comprising means for transmitting a request to initiate authentication with the authentication server.

17. The apparatus of claim 11, further comprising means for receiving a beacon message periodically from the access point, the beacon message comprising information on how the apparatus can communicate with the access point and capabilities of the access point, and capabilities of the access point comprising a fast initial link setup association power save mode that allows the apparatus to transition into the sleep state in response to receiving the authentication response.

18. The apparatus of claim 11, further comprising:
means for transmitting a probe request to the access point, the probe request comprising a request for information related to a wireless network managed by the access point; and
means for receiving a probe response from the access point, the probe response comprising information on how the apparatus can communicate with the access point and capabilities of the access point, and capabilities of the access point comprising a fast initial link setup association power save mode that allows the apparatus to transition into the sleep state in response to receiving the authentication response.

19. The apparatus of claim 11, the means for transmitting the authentication request and the means for transmitting the association request comprising a transmitter, the means for receiving the authentication response and the means for receiving the association response comprising a receiver, and the means for transitioning from the awake state to the sleep state comprising a power save controller.

20. A non-transitory computer-readable medium comprising code that, when executed, causes an apparatus to:
transmit an authentication request to an access point and for the access point to transmit an authentication initiation request to an authentication server;
receive an authentication response comprising an estimated response delay from the access point ;
transition from an awake state to a sleep state in response to receiving the authentication response for a duration of time based on the estimated response delay;
transmit an association request to the access point after the duration of time and transitioning from the sleep state to the awake state; and
receive an association response from the access point in response to transmitting the association request, the association response comprising an authentication status received by the access point from the authentication server, and the authentication status indicating whether authentication with the authentication server is successful.

21. The medium of claim 20, further comprising code that, when executed, causes an apparatus to receive the authentication response after the access point transmits the authentication initiation request to the authentication server.

22. The medium of claim 20, the access point determining the estimated response delay based on at least one of a duration of time that the authentication server took to respond to a previous authentication initiation request transmitted to the authentication server at a time before transmission of the authentication initiation request, a set value, a load of the authentication server, or a combination thereof

23. The medium of claim 20, the authentication status comprising at least one of an extensible authentication protocol (EAP) success message or an EAP failure message.

24. The medium of claim 20, the authentication request further comprising a request for a power-save operation, and wherein the estimated response delay is received in response to transmission of the request for the power-save operation.

25. The medium of claim 20, further comprising code that, when executed, causes an apparatus to transmit a request to initiate authentication with the authentication server.

26. The medium of claim 20, further comprising code that, when executed, causes an apparatus to receive a beacon message periodically from the access point, the beacon message comprising information on how the apparatus can communicate with the access point and capabilities of the access point, and capabilities of the access point comprising a fast initial link setup association power save mode that allows the apparatus to transition into the sleep state in response to receiving the authentication response.

27. The medium of claim 20, further comprising code that, when executed, causes an apparatus to:
transmit a probe request to the access point, the probe request comprising a request for information related to a wireless network managed by the access point; and
receive a probe response from the access point, the probe response comprising information on how the apparatus can communicate with the access point and capabilities of the access point, and capabilities of the access point comprising a fast initial link setup association power save mode that allows the apparatus to transition into the sleep state in response to receiving the authentication response.

28. An apparatus for communicating data in a wireless communications network, comprising:
a transmitter configured to transmit an authentication request to an access point and for the access point to transmit an authentication initiation request to an authentication server;
a receiver configured to receive an authentication response comprising an estimated response delay from the access point; and
a power save controller configured to transition the apparatus from an awake state to a sleep state in response to receiving the authentication response for a duration of time based on the estimated response delay,
the transmitter further configured to transmit an association request to the access point after the duration of time and transitioning from the sleep state to the awake state, and
the receiver further configured to receive an association response from the access point in response to transmitting the association request, the association response comprising an authentication status received by the access point from the authentication server, and the authentication status indicating whether authentication with the authentication server is successful.

29. The apparatus of claim 28, the receiver further configured to receive the authentication response after the access point transmits the authentication initiation request to the authentication server.

30. The apparatus of claim 28, the access point determining the estimated response delay based on at least one of a duration of time that the authentication server took to respond to a previous authentication initiation request transmitted to the authentication server at a time before transmission of the authentication initiation request, a set value, a load of the authentication server, or a combination thereof

31. The apparatus of claim 28, the authentication status comprising at least one of an extensible authentication protocol (EAP) success message or an EAP failure message.

32. The apparatus of claim 28, the authentication initiation request being an extensible authentication protocol (EAP) request.

33. The apparatus of claim 28, the authentication request further comprising a request for a power-save operation, and wherein the estimated response delay is received in response to transmission of the request for the power-save operation.

34. The apparatus of claim 28, the transmitter further configured to transmit a request to initiate authentication with the authentication server.

35. The apparatus of claim 28, the association response further comprising a key confirmation and a group-key distribution.

36. The apparatus of claim 28, the receiver further configured to receive a beacon message periodically from the access point, the beacon message comprising information on how the apparatus can communicate with the access point and capabilities of the access point, and capabilities of the access point comprising a fast initial link setup association power save mode that allows the apparatus to transition into the sleep state in response to receiving the authentication response.

37. The apparatus of claim 28, the transmitter further configured to transmit a probe request to the access point, the probe request comprising a request for information related to a wireless network managed by the access point.

38. The apparatus of claim 37, the receiver further configured to receive a probe response from the access point, the probe response comprising information on how the apparatus can communicate with the access point and capabilities of the access point, and capabilities of the access point comprising a fast initial link setup association power save mode that allows the apparatus to transition into the sleep state in response to receiving the authentication response.
